(19) United States
(12) Patent Application Publication
(10) Pub. No.: US 2024/0020778 A1
(43) Pub. Date: Jan. 18, 2024

(54) DYNAMIC DATA RESOURCE DRIVEN USER INTERFACE TOOL

(71) Applicant: Black Hills IP Holdings, LLC, Minneapolis, MN (US)

(72) Inventors: Steven W. Lundberg, Edina, MN (US); Elliott M. Higgins, Vadnais Heights, MN (US)

(21) Appl. No.: 18/351,416

(22) Filed: Jul. 12, 2023

Related U.S. Application Data
(60) Provisional application No. 63/388,559, filed on Jul. 12, 2022.

(51) Int. Cl. G06Q 50/18; G06F 9/451; G06Q 10/0633; G06F 40/169; G06F 40/117; G06F 3/04847

(52) U.S. Cl. CPC G06Q 50/184; G06F 9/451; G06Q 10/0633; G06F 40/169; G06F 40/117; G06F 3/04847

(57) ABSTRACT

Various embodiments disclosed relate to a dynamic data resource driven user interface. The present disclosure includes a system having a data resource comprising data related to one or more tasks to be worked on, the data comprising one or more deadlines, documents, and other items related to the task to be worked on; a dynamic data resource driven user interface tool for use in completing the one or more tasks to be worked on, the dynamic data resource driven user interface tool configured to dynamically update; wherein the dynamic data resource driven user interface tool comprises: one or more reading panes for displaying at least a portion of the data related to one or more tasks to be worked on; and one or more editing panes for production of a new document related to the one or more tasks to be worked on; wherein the dynamic data resource driven user interface tool is configured to: interact with the data resource; retrieve data from the data resource; produce the data from the data resource on the dynamic data resource driven user interface tool; and dynamically update the dynamic data resource driven user interface.

### CLAIM OF PRIORITY

This application claims the benefit of priority under 35 U.S.C. § 119(e) to U.S. Provisional Patent Application Ser. No. 63/388,559, filed on Jul. 12, 2022, and which is incorporated by reference herein in its entirety.

### TECHNICAL FIELD

The application is directed toward an electronic docketing system, and more specifically, to an electronic docketing system that provides a dynamic data resource driven user interface.

### BACKGROUND

In patent prosecution, a large amount of data and documents are received and docketed during the course of a patent application lifetime. Docketing systems can be used to track workflow deadlines, tasks, and progress. For example, in a given project, a docketing system can track when the project is opened, what initial filings are due when, and correspondence coming in regarding that project. The docketing system can additionally be used to record deadlines and flag correspondence or documents that can require a response. In such a general setting, a large number of items and tasks are incoming and often need to be sorted during docketing. These items and tasks are then picked up by practitioners to address prior to deadlines.

This influx of information is complicated by the information desired by a patent practitioner when working on a patent prosecution task. For example, an office action can be received by the firm and docketed for response. The patent practitioner can pick up the office action, intending to prepare a response before the docketed deadline. However, to prepare such a response, the patent practitioner can require reviewing more than just the office action. The patent practitioner can desire to review the file history, the application itself, prior art documents, prior responses, and other documents.

### SUMMARY OF THE DISCLOSURE

The present disclosure provides a method and system for leveraging a data resource for production of a dynamic data resource driven user interface. The method leverages data from a variety of sources, such as internal docketing systems, governmental databases, foreign agents, external docketing systems, and other intellectual property management systems. This data can be aggregated in a data resource and selectively pulled to populate a dynamic data resource driven user interface, such as a patent prosecution user interface.

The dynamic data resource driven user interface can, for example, include reading panes for pertinent documents, easy access to form text or law, and a variety of other customizable tools for the patent prosecutor.

When a practitioner starts a patent prosecution task, they likely desire to have access to a variety of documents. For example, the patent application pending claims, the communication from the patent office, the specification of the pending application, and any prior art documents can be desired when preparing a response. Similarly, the practitioner can desire to have other information in addition to documents, such as deadlines, patent examiner statistics, dynamic copies of the claims, form text, and other items, to help in the practitioner's preparation of a document in the case.

However, these documents and various pieces of information are often scattered throughout a variety of different sources, such as internal docketing systems, email chains, governmental databases, the practitioner's computer files and folders, and other areas. The practitioner generally must manually aggregate the information when preparing to accomplish a patent prosecution task. Even then, the practitioner can find themselves switching between a variety of documents, paper or electronic, and through various screens, applications, and copies of items and information.

The system and methods described herein can allow for an automated aggregation of patent documents and information for presentation in a dynamic data resource driven user interface. The patent practitioner can use the dynamic data resource driven user interface during prosecution tasks to see and interact with relevant information and documents, such as while preparing a new document such as an office action response or a letter.

The discussed methods and systems here have a variety of advantages, some of which are unexpected. For example, a patent practitioner using the dynamically updating data resource driven tool can more efficiency produce documents, responses, letters, and complete other tasks during their workday.

In an example, a method includes receiving an indication of a task to be worked on; automatically scraping documents and data from a computer to a data resource; deriving annotations from the scraped documents and data and adding those derived annotations to the data resource, the scraped documents and data associated with the task to be worked on; receiving a selection of one or more tags, annotations, or labels applicable to the task to be worked on; tagging, annotating, or labelling data in the data resource; selectively retrieving data related to the task to be worked on from the data resource; wherein selectively retrieving data related to the task to be worked on comprises: retrieving one or more documents; retrieving information for display; retrieving editable text; and retrieving metadata; filtering the retrieved data according to the selected one or more tags, annotations, or labels; and displaying the filtered retrieved data on a dynamic data resource driven user interface tool comprising at least one editing pane.

In an example, a method includes tagging stored data in a data resource with a plurality of tags indicative of data type; retrieving the stored data from the data resource; applying a filter to select a portion of the plurality of tags, and; displaying a filtered portion of the stored data based on the filter on a user interface as a dynamic data resource driven user interface tool, wherein displaying the filtered portion of the stored data comprises displaying editable text, documents, moveable images, displayed data, or combinations thereof on the user interface, and wherein the dynamic data resource driven user interface tool is configurable and updatable by a user.

In an example, a system includes a data resource comprising data related to one or more tasks to be worked on, the data comprising one or more deadlines, documents, and other items related to the task to be worked on; wherein the data resource is configured to: interface with an internal docketing system, interface with an external docketing system, and interface with an annotation system; a dynamic data resource driven user interface tool for use in completing the one or more tasks to be worked on, the dynamic data resource driven user interface tool configured to dynamically update, wherein the dynamic data resource driven user interface tool comprises a template for one or more tasks to be worked on, the template populated by the dynamic data resource driven user interface tool with the data related to one or more tasks to be worked on; wherein the dynamic data resource driven user interface tool comprises: one or more reading panes for displaying at least a portion of the data related to one or more tasks to be worked on; and one or more editing panes for production of a new document related to the one or more tasks to be worked on; wherein the dynamic data resource driven user interface tool is configured to: interact with the data resource; retrieve data from the data resource; produce the data from the data resource on the dynamic data resource driven user interface tool; and dynamically update the dynamic data resource driven user interface.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various embodiments discussed in the present document.

FIGS. 1A-1B are schematic diagrams of a data resource driven patent prosecution system 100 in an example.

FIG. 2 is a schematic representation of data resource sources of information in an example.

FIGS. 3A to 3C are schematic representations of a data resource driven patent prosecution user interface in an example.

FIGS. 4A-4E are flowcharts depicting a data resource driven patent prosecution process in an example.

FIG. 5 is a flowchart depicting a method of using a data resource driven patent prosecution system.

FIG. 6 is a schematic diagram of a computer system in an example.

### DETAILED DESCRIPTION

The present disclosure describes, among other things, a dynamic data resource driven user interface tool. The dynamic data resource driven tool can be a dynamically updatable user interface for use by a patent practitioner when preparing documents, such as office action responses, patent applications, instructions to foreign counsel, or other materials. The dynamic data resource driven tool can be supported by a data resource of data related to a task to be worked on. The tool can automatically pull desired data and documents from the data resource regarding the task to be worked on. The data and documents can be filtered from the data resource based on a series of annotations or “tags” that have been automatically assigned to various portions of data and documents. The data pulled from the data resource can populate the dynamic data resource driven tool's user interface and be dynamically updatable as desired by a user during use.

As used herein, “annotation”, “tag”, or “label” refers to documentation and comments that can be found on code logic, often as metadata. The annotation can describe one or more bibliographic or useful descriptions related to the data. An annotation is extra information associated with a particular point in a document or other piece of information. It can be a note that includes a comment or explanation in the code.

As used herein, “application” or “program” can include a program or piece of software designed and written to fulfill a particular purpose of the user, such as a database application.

As used herein, “associate” can include a partner or colleague in business or at work, either internal or external.

As used herein, “data resource” refers to a centralized repository designed to store, process, and secure large amounts of structured, semi-structured, and unstructured data. It can store data in its native format and process any variety of it, ignoring size limits. In some cases, a data resource can include a data lake.

As used herein, “database” can refer to a structured set of data, such as held in a computer or on the internet, that can be accessible in various ways.

As used herein, “electronic communication” refers to an electronic message or a method of exchanging messages between people using electronic devices.

As used herein, “file” or “matter” can refer to a particular project, enterprise, or undertaking being worked on by an individual or a collaborative group, planned and designed to achieve a particular aim.

As used herein, “official record” or “file history” can refer to data about a file or matter denoting evidence about past events or tasks within that file or matter, such as an electronic record of previous events in the file or matter. An “official record” can be stored with and maintained by an overseeing agency or organization, such as a governmental organization. As used herein, “patent practitioner” refers to a professional licensed by the United States Patent and Trademark Office (USPTO) to advise on and assist inventors with patent applications in the U.S., or a professional licensed by an international patent office to advise and assist inventors with patent applications in the corresponding country.

As used herein, “portfolio” can refer to a group of patent filings, such as related patents, patent filings of common ownership, patent filings of common inventorship, or other combinations thereof.

As used herein, “scraping”, “web scraping”, “data scraping”, or “web crawling” can refer to automatically mining or collecting data or information, such as from a database or the internet.

As used herein, “structured text” or “structured data” refers to data that is organized in a standard format such that a recipient can read the data and institute an automated computing system action without human interpretation of the data.

As used herein, “transfer”, “transferring”, or “transferred” can refer to the movement of an intellectual property portfolio from one law firm to another, such as directed by a client.

As used herein, “unstructured text” or “unstructured data” refers to data that is not organized in a standard format, for example, text in the body of an electronic communication.

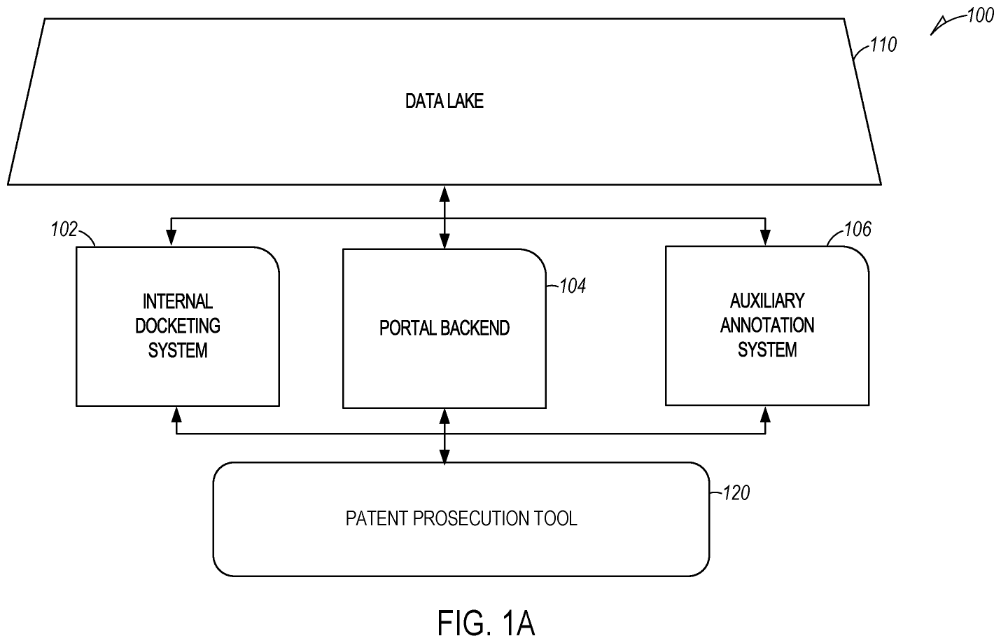

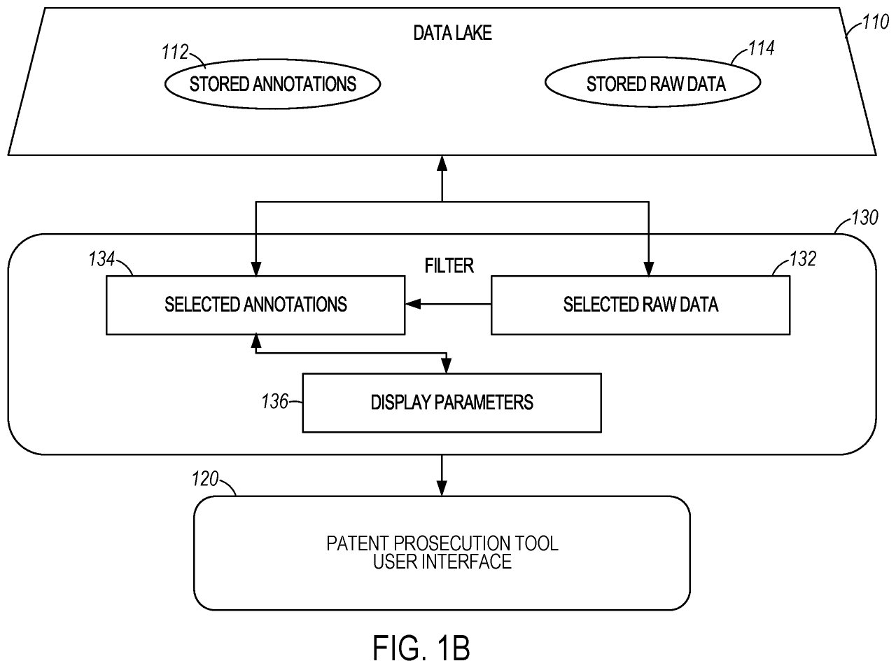

FIGS. 1A-1B are schematic diagrams of a dynamic data resource driven system 100 in an example. The system 100 can include the data resource 110 and the patent prosecution tool 120, which interact through an internal docketing system 102, a portal backend 104, and an auxiliary annotation system 106. The data resource 110 can include stored annotations 112 and stored raw data 114. A filter 130 can be configurable to draw data from the data resource 110 to the patent prosecution tool 120 working through the internal docketing system 102, the portal backend 104, and the auxiliary annotation system 106. The filter 130 can leverage selected raw data 132, selected annotations 134, and display parameters 136, to produce the patent prosecution tool 120 user interface.

The dynamic data resource driven system 100 can work in conjunction with an automated or semi-automated docketing system. For example, the data resource 110 can be configured to interface with an internal docketing system. In some cases, the data resource 110 can be configured to interface with an external docketing system.

The data resource 110 can be a centralized repository designed to store, process, and secure large amounts of structured, semi-structured, and unstructured data, such as related to a patent portfolio. The data resource 110 can contain data related to patent prosecution files and filings. In some cases, the data can include information related to deadlines, documents, and other items related to the patent prosecution files.

In some cases, the data resource can contain patent files for a single client. In some cases, the data resource can contain patent files for all clients a firm works with. In some cases, a large number of patent filings, related documents and data, can be located in the data resource 110. Example data and documents can include patent filing records, patent office communications, correspondence about the patent filing, and other information. Such information can be stored in the data resource 110 in an unstructured, semi-structured, or structured, format, depending on the information's origin. Such information can comprise the raw data 114 in the data resource 110.

The data resource 110 can be configured to interface with an annotation system, which can create and provide annotations associated with various portions of the stored raw data 114. These stored annotations 112 can be used when data is pulled from the data resource 110.

Data for the data resource 110 can be retrieved from a variety of places, such as a governmental database (e.g., the USPTO Patent Center), internal systems such as AAS systems and docketing systems, or other portal systems. These sources can be accessed through the data resource 110 that the patent prosecution tool 120 calls to gain access to the various sources of data. In an example, the data for some of those sources is stored within those sources themselves, such as in the form of SQL databases.

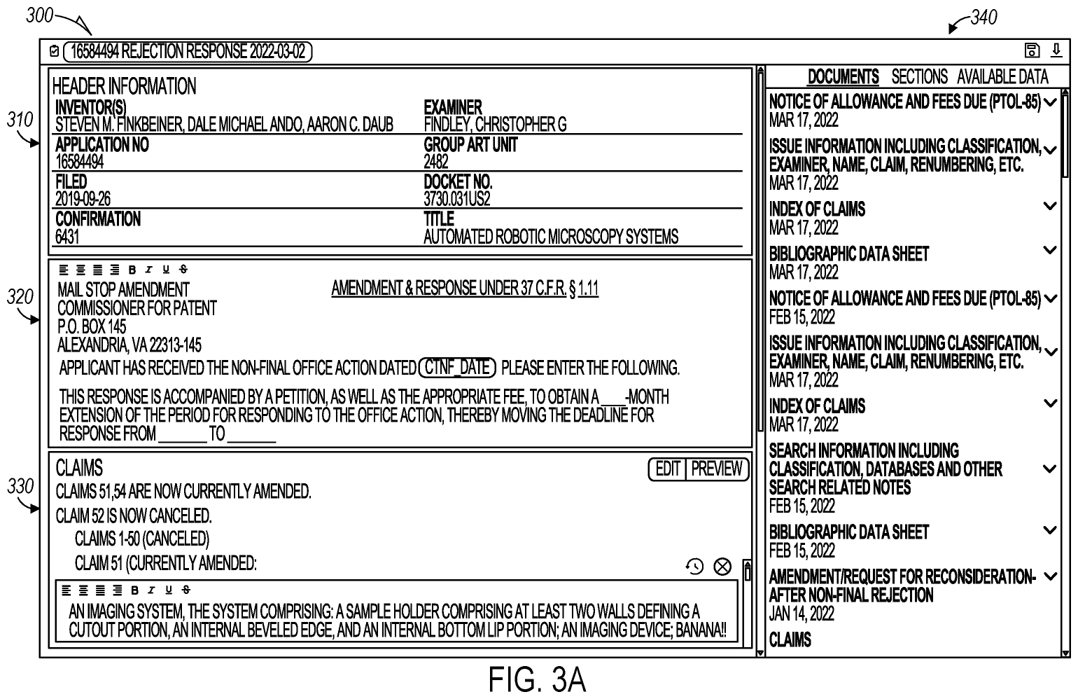

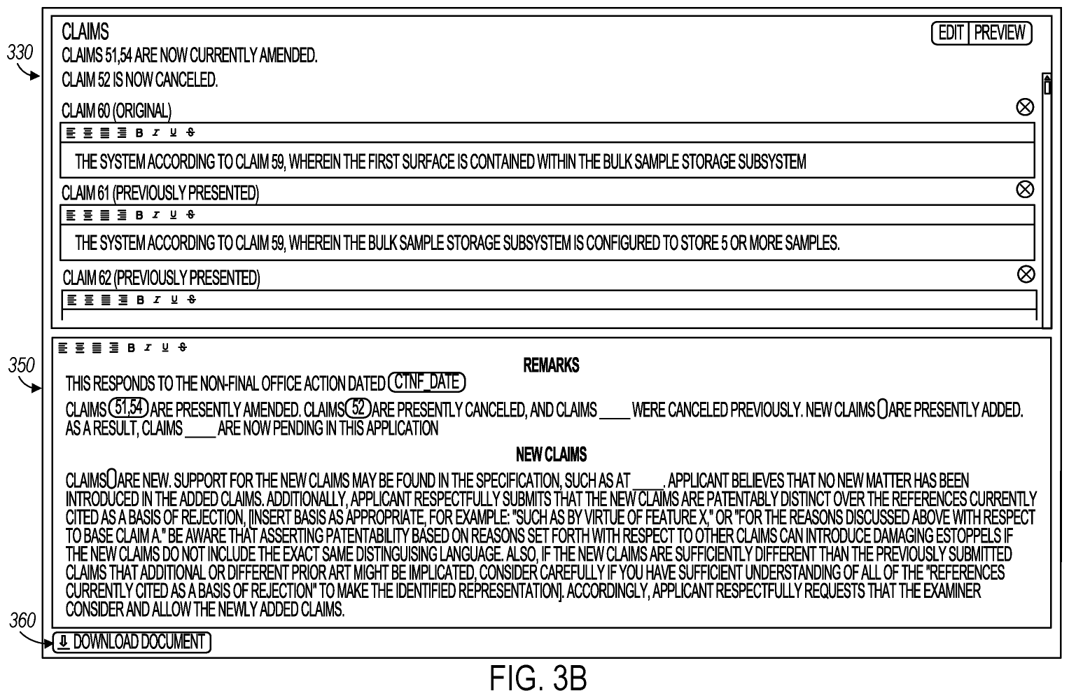

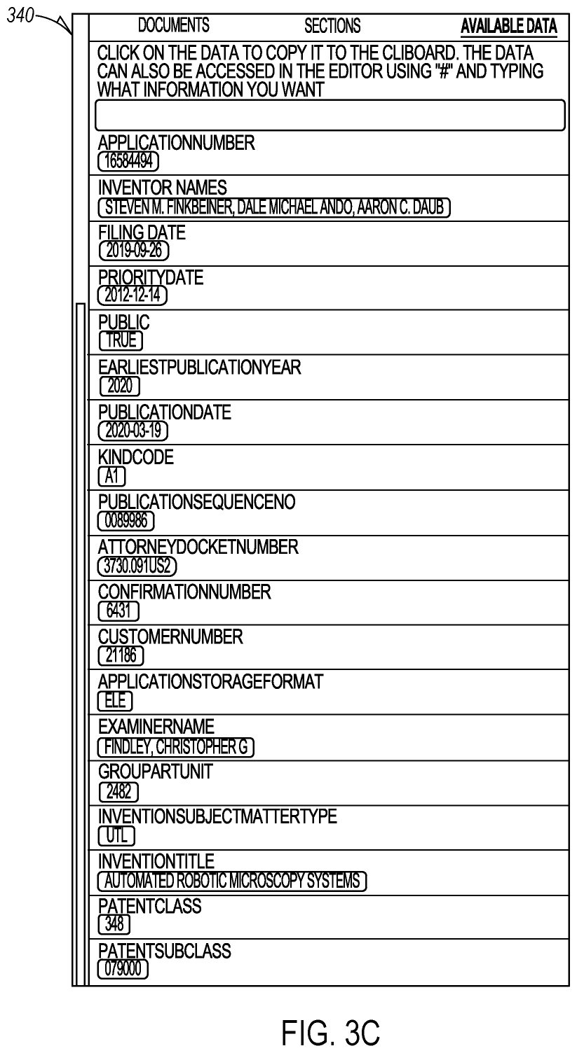

The patent prosecution tool 120 can be a program configured to interact with the data resource 110. The patent prosecution tool 120 can be a program configured to retrieve data from the data resource 110, produce the data from the data resource 110 on a user interface, and dynamically update the user interface. Example user interfaces are shown and discussed below with reference to FIGS. 3A-3C. The patent prosecution tool 120 can be leveraged by a patent practitioner for a streamlined production of patent prosecution documents for a given case.

The internal docketing system 102 can be, for example, a docketing system maintained by a patent practitioner's organization, such as a private firm or a corporation. The internal docketing system 102 can, for example, be used to collect, track, and maintain patent files. The internal docketing system 102 can be used, for example, to create tasks and deadlines, and to follow up on those tasks and deadlines. The data resource 110 and the patent prosecution tool 120 can interact with the internal docketing system 102, and can transfer, read, and review data therebetween.

The portal backend 104 can be a cloud-based or web-based platform that aggregates information from different sources, such as the data resource 110, into a single user interface such as the patent prosecution tool 120 and presents users with the most relevant information. The portal backend 104 can interface with the data resource 110 and the patent prosecution tool 120 to move the appropriate information to the patent prosecution tool 120 for a patent practitioner.

The auxiliary annotation system 106 can be an integrated or separate system that works with the data resource 110 and the patent prosecution tool 120. The auxiliary annotation system 106 can be used to sort data, such as data in the data resource 110, and apply annotations, tags, or labels to that data, such as prior to moving that data to the patent prosecution tool 120. The auxiliary annotation system 106 can be used to annotate stored raw data 114 in the data resource 110.

The filter 130 can be applied to the selected raw data 132 in the data resource 110 to filter the data based on the selected annotations 134 and pull data into the patent prosecution tool 120. The display parameters 136 can be applied to the data to display the desired data on the user interface of the patent prosecution tool 120. The user interface can be for use by a patent prosecutor in preparing a response to a patent prosecution task.

The user interface can be configured to dynamically update as a user changes the selected annotations 134 and the filter 130 changes which selected raw data 132 is pulled from the data resource 110 into the patent prosecution tool 120. In some cases, the user interface can show a template for patent prosecution tasks. In some cases, the template is populated by the dynamic data resource driven user interface tool with the data related to one or more tasks to be worked on. In some cases, the user interface can include one or more reading panes for displaying at least a portion of the data related to one or more tasks to be worked on. In some cases, the user interface can include one or more editing panes for production of a new document related to the one or more patent prosecution files.

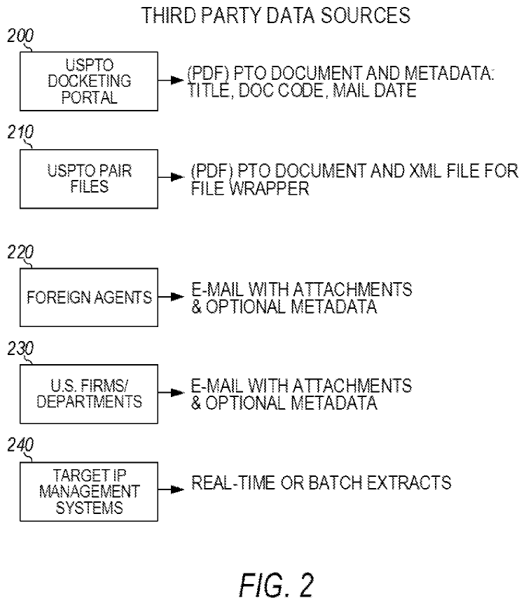

FIG. 2 illustrates sample third-party data sources that provide data input for the system 100 implemented for managing patent portfolios in an example. As illustrated in FIG. 2, the third-party data sources can include the Patent Office (e.g., USPTO) docketing portal 200, which provides documents from the USPTO in portable document format (PDF) and includes metadata identifying the title, document code, and mail date for the corresponding document. The third-party data sources can further include USPTO PAIR extensible markup language (XML) files 210, which provide documents from the USPTO in PDF format and includes an XML, file for patent file wrappers. The third-party data sources can also include foreign agents 220 who provide emails with attachments and optional metadata. Foreign agents 220 can also provide hard copy documents that can be scanned for data entry. Similarly, law firms and/or corporate law departments 230 can provide emails with attachments and optional metadata as well as hard copy documents that can be scanned for data entry. Also, third-party docketing systems 240 can provide real-time or batch extracts of data for entry into a docketing management system. Any of these sources of data can feed into the patent prosecution tool 120.

FIGS. 3A to 3C are schematic representations of a dynamic data resource driven user interface 300 in an example. The dynamic data resource driven user interface 300 can include header information window 310, task window 320, first drafting window 330, second drafting window 350, download document button 360, and annotations window 340.

The dynamic data resource driven user interface 300 can be a software tool used by a patent practitioner to prepare documents related to patent practice. For example, if an office action is received from the USPTO, and the office action includes a final rejection of a patent application, the dynamic data resource driven user interface 300 can be used by a patent practitioner to prepare a response to the office action, such as an amendment.

The dynamic data resource driven user interface 300 can include one or more drag and drop windows or fields for a patent practitioner working on a patent file task. The one or more drag and drop windows or fields can be customizable, moveable, and replaceable. Different combinations of windows or fields can be used, showed, and interacted with, depending on how the patent practitioner configures the dynamic data resource driven user interface 300. In some cases, more or less windows can be used. The combinations of windows shown and discussed with reference to FIGS. 3A-3C is one example of such a configuration.

In this example, the dynamic data resource driven user interface 300 can include a header information window 310, which can, for example, include bibliographic information about the patent file being worked on. For example, a patent application number, a patent publication number, assignee, inventor(s), filing date, and other information that can be useful to the patent practitioner working on the case.

The task window 320 can, for example, highlight, point out, or otherwise display, the task being worked on. For example, when an office action response is being worked on, the task window 320 can display the appropriate bibliographic information related to the office action response, such as a header, date, and identification of the case being worked on.

The first drafting window 330 can, for example, contain patent claims that are text editable. In the example shown in FIGS. 3A-3C, the first drafting window 330 can be a claim drafting window. In The first drafting window 330, the currently pending claims are displayed, with claim indicators, such as (Canceled), (Original), etc. The currently pending claim text can be displayed as editable text so that the user can easily revise and manipulate the claims as desired for amendments. In some cases, the claim text can be displayed in an embedded window, with formatting options such as underline and strikethrough. In some cases, the claim text can be editable such that changes to the claim text automatically underline new additions and strikethrough deletions. In some cases, the claim text in the first drafting window 330 can include an undo or redo button to revert claims to a previous variant. In some cases, the claim indicators can be configured to automatically update when a claim is amended. In some cases, the claim text can be configured to be automatically deleted when a user indicates a claim should be canceled.

The second drafting window 350 can, for example, contain a field for remarks, such as remarks in an office action response. In the example shown in FIGS. 3A-3C, the second drafting window 350 can be a text editable field set up in an appropriate organization for preparing an office action response, such as an amendment. The second drafting window 350 can include a header section, such as text indicating “This responds to the Non-Final Office Action dated . . . ” The dynamic data resource driven user interface 300 can automatically update various pieces of information, such as the date of the office action, the claims that have been amended, the claims that have been canceled, the claims that have been added, and other items, depending on the data pulled from the data resource into the dynamic data resource driven user interface 300.

The second drafting window 350 can additionally include one or more template text sections, such as automatically generated form text useful when drafting an office action response. For example, a sub-section titled “New Claims” can be included, which include an automatically generated topic sentence that identifies new claims, and other descriptive text describing where support for new claims can be found. Similarly, the second drafting window 350 can include other pieces of form text useful to the patent practitioner, such as opening sentences for responding to various types of rejections.

In some cases, the dynamic data resource driven user interface 300 can additionally include one or more panels that includes various form text responses for the user to drag and drop where appropriate into the second drafting window 350. For example, text regarding a drawing objection can be selected, dragged, and dropped into the second drafting window 350 for use when a drawing was objected to in the office action.

The download document button 360 can allow for saving and production of a document, such as an office action response, drafted with the dynamic data resource driven user interface 300. For example, the patent practitioner can insert claim amendments into first drafting window 330, insert remarks into second drafting window 350, and then selected the download document button 360 to produce a full document of the office action response, such as in a PDF or Word format. The download document button 360 can be used to produce such a document in a useable fashion, such as for emailing, printing, reviewing, sending, or filing.

The annotations window 340 can interface with the rest of the windows in the dynamic data resource driven user interface 300. The annotations window 340 can allow the patent practitioner to customize the information and fields displayed in the dynamic data resource driven user interface 300. The annotations window 340, for example, can include a variety of options for selection of documents and available data for display or use. The annotations window 340 can additionally display a number of options for the sections, e.g., the types of windows, displayed in the dynamic data resource driven user interface 300.

A user, such as a patent practitioner, can use the various annotation options available in the annotations window 340 to dynamically update the dynamic data resource driven user interface 300. For example, the dynamic data resource driven user interface 300 can be initialized with a default setting, where a default filter is used to pull and display desired data from the data resource. Then, the user can add or remove desired annotations to alter how the filter functions and which data and annotations are selected. In this way, the dynamic data resource driven user interface 300 can be customizable. A user can update the dynamic data resource driven user interface 300 concurrently while working in the dynamic data resource driven user interface 300 and can update or alter the selected annotations at any time.

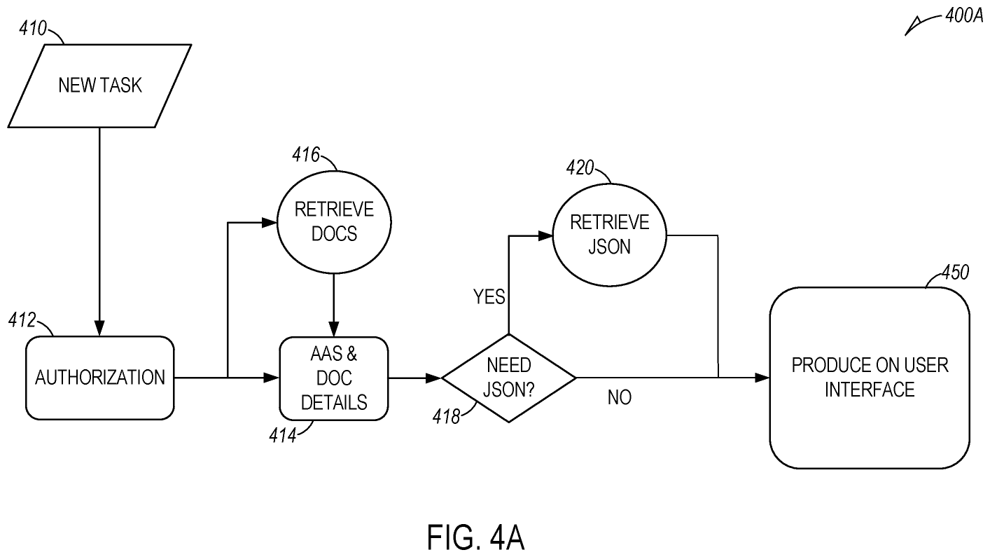

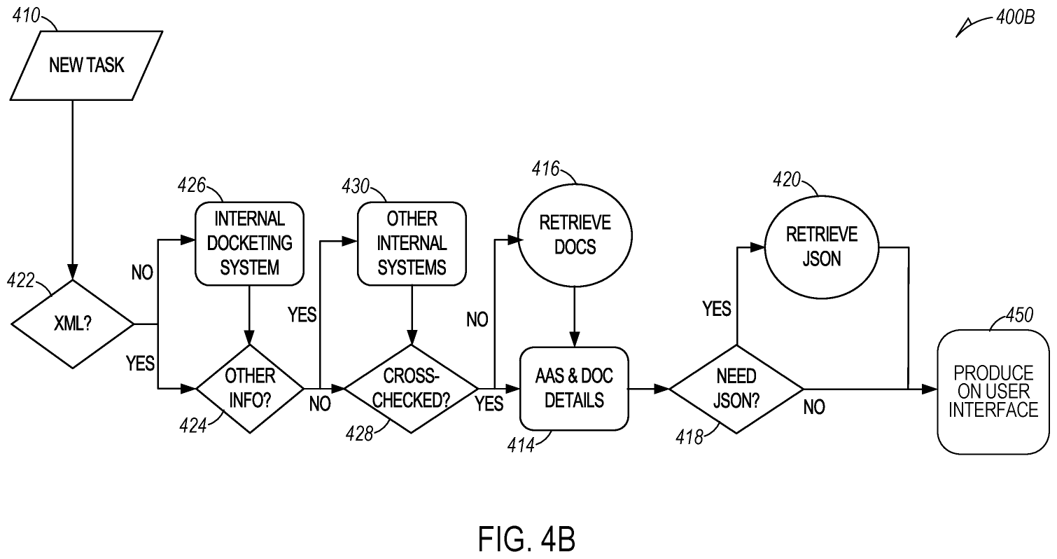

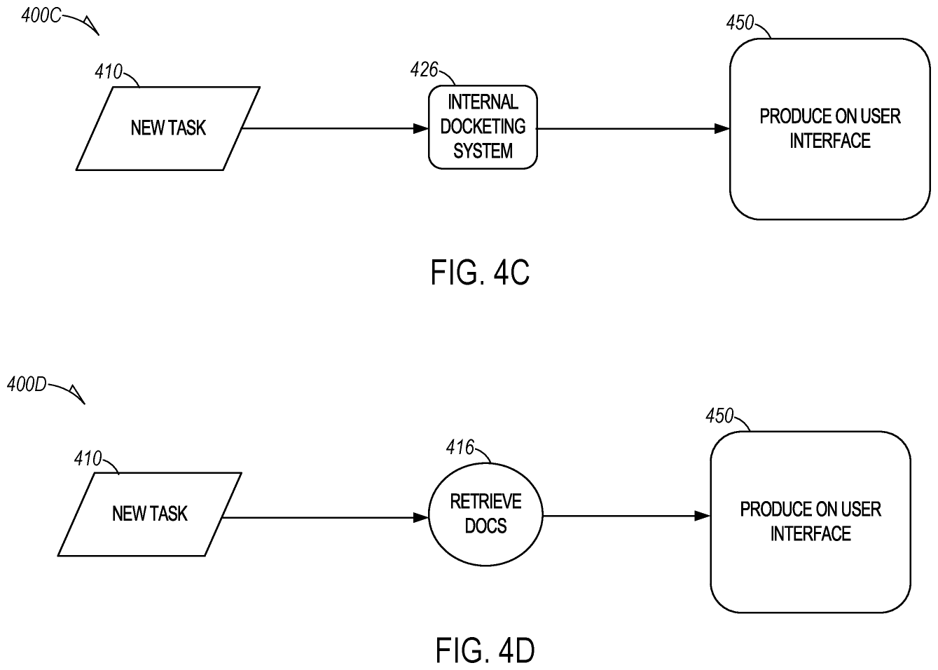

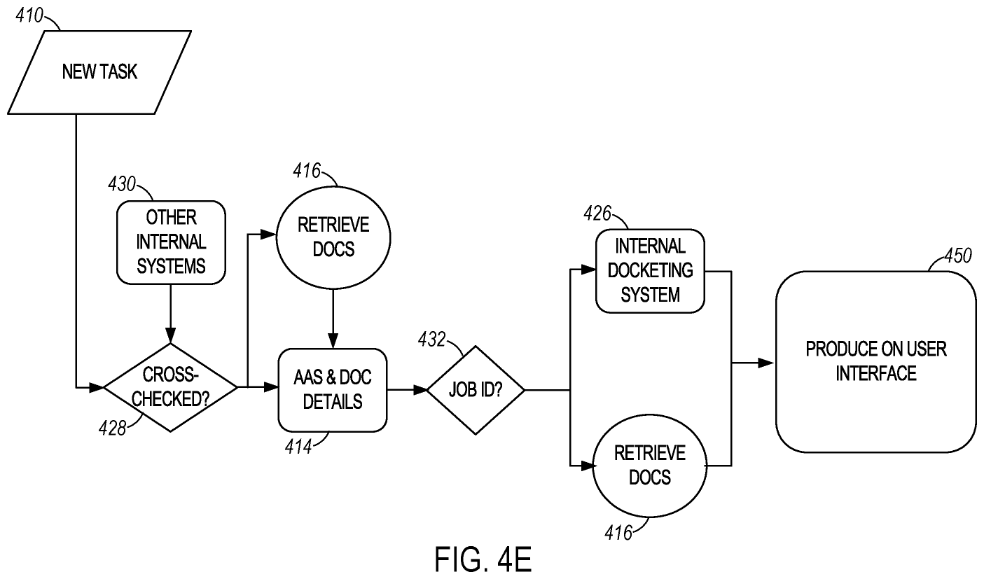

FIGS. 4A-4E are flowcharts depicting processes 400A to 400E of a dynamic data resource driven system in an example. The various processes can include steps such as new task 410, authorization 412, automated annotation 414, retrieval of documents 416, JSON review 418, JSON retrieval 420, XML confirmation 422, additional information retrieval 424, internal docketing system coordination 426, cross-checking 428, coordination with other internal systems 430, job identification confirmation 432, and combinations thereof for production of a user interface 450.

In process 400A, a new task 410 is selected. For example, a patent practitioner can notice an office action has been received from a patent office. Perhaps the office action includes a non-final rejection of a case that has just undergone a request for continued examination (RCE). In the case of process 400A, the system can request authorization 412 to proceed, such as can be confirmed by the user, or by an automated or semi-automated process. In some cases, the initial identification of the matter to be worked on can be a customer number or other identification number.

Next, the system can determine whether it needs to retrieve the appropriate documents at step 416. At this step, the system can determine whether (1) the documents of interest are already in the data resource or (2) the documents need to be placed in the data resource. If the first, the system can proceed to step 414. If the second, the system can work to retrieve the appropriate documents. For example, the documents can be scraped from a governmental database, a third-party system, or an internal communication. In this case, the documents can then be placed in the data resource. For example, where a U.S. office action has recently issued, the system can work to scrape the office action from the USPTO PAIR database and place it in the data resource.

At this point, newly retrieved documents in the data resource can be annotated, such as through optical character recognition (OCR) and an auxiliary annotation system (AAS). For example, with documents in the data resource, a data extraction program within the system can perform OCR on the received documents to extract data, read checkboxes, extract lists, and identify documents where possible. The system can also integrate with an AAS to add annotations to the documents in the data resource based on complex data extraction. Such an AAS can further identify the received documents without using an OCR. In some cases, the annotations can be applied to the documents as they are being moved into the data resource. In an example, where a newly received office action has been placed in the data resource, a variety of annotations might be applied to that document, such as a receipt date, annotations regarding types of claims and claim status, annotations regarding prior art retrieval, and more.

Once document retrieval and annotation within the data resource has been confirmed, the system can move to step 414, automated annotation selection. In this case, document details can be determined, and desired annotations can be selected from documents as needed. For example, if the user desires to produce a patent prosecution tool user interface for preparing an amendment and response to a newly received office action, the system can select annotations that help produce a claims window, a remarks editing window, and a bibliographic window, such as shown and discussed above with reference to FIGS. 3A-3C.

At step 418, the system can ask whether a JavaScript object notation (JSON) file is desired. Such a JSON file can, for example, be an open standard file format and data interchange format that uses readable text to store and transmit data. For example, a JSON file can be desired with a response to an office action if such a JSON file includes prior claim amendments, cited prior art, or other documents or information useable to the patent practitioner within the dynamic data resource driven user interface. If a JSON file is desired, it is retrieved at step 420.

Finally, at step 450, the user interface is produced, using the retrieved documents, their chosen annotations, and potentially the JSON file. The user interface produced at step 450 can be, for example, a dynamically updatable user interface for a patent practitioner prosecuting patents.

Process 400B is similar to process 400A, with some changes depending on the initial source of data and documents used. For example, in process 400B, the initial information can be retrieved from the USPTO. In process 400B, a new task can be opened at step 410. There, instead of a separate user-driven or automated authorization, the system goes directly into checking for an appropriate extensible markup language (XML) file at step 422. An XML, file is a markup language and file format for storing, transmitting, and reconstructing arbitrary data. The USPTO has recently begun using XML files extensively in patent prosecution.

In the case of process 400B, the system can begin by asking whether an XML file is present for the task being worked on at step 422. If the XML file is not present, the system can revert to an internal docketing system to retrieve the desired documents (step 426). If the XML file is indeed present, the system can ask whether other information is desired. If more information is desired, the system can check other internal systems (step 430).

Once no other information is desired from XML, an internal docketing system, or other internal systems, the system can cross-check the information to determine whether the appropriate data, documents, and associated annotations are present (step 428). If cross-checking of annotations and documents has not occurred, the system can optionally retrieve additional documents, such as from a third-party source as described above (step 416) and then apply annotations as needed, such as described above, using OCR, AAS, and other appropriate methods.

After cross-checking of annotations and documents has occurred, the system can select the desired annotations for this new task in preparation for the production of the user interface (step 414). In this case, document details can be determined, and desired annotations can be selected from documents as needed. For example, if the user desires to produce a dynamic data resource driven user interface for preparing an amendment and response to a newly received office action, the system can select annotations that help produce a claims window, a remarks editing window, and a bibliographic window, such as shown and discussed above with reference to FIGS. 3A-3C.

At steps 418 and 420, review and retrieval, if necessary, for a desired JSON file can be done.

At step 450, the user interface can be produced. The user interface produced at step 450 can be, for example, a dynamically updatable user interface for a patent practitioner prosecuting patents.

Process 400C can be a simplified version of the processes described above, such as for retrieval of documents from the USPTO. In process 400C, the system can receive an indication of a new task to be worked on at step 410. Next, the system can retrieve documents with associated annotations from the data resource, such as through an internal docketing system (step 426). The system can then produce the user interface based on the retrieved documents and annotations at step 450.

Process 400D can be a simplified version of the processes described above, such as for download of documents from the USPTO. In process 400D, the system can receive an indication of a new task to be worked on at step 410. Next, the system can retrieve documents with associated annotations from a third-party source, such as a governmental database (step 416). The system can then produce the user interface based on the retrieved documents and annotations at step 450.

Process 400E can be similar to the processes described above, such as for download of particular documents in the user interface. Process 400E can begin with the system receiving an indication of a new task at step 410. Next, the system can determine whether information and desired annotations associated with the new task have been cross-checked, such as described above (steps 428 and 430). At step 414, the desired annotations can be selected.

At step 432, the particular file, matter, or task being worked on can be identified, either by a user, or in an automated fashion. For example, automated or semi-automated review of the task can reveal a matter number associated with the file. Once the job is identified, the system can turn to the internal docketing system (step 426) and/or external sources (step 416) to retrieve the associated documents desired for work on the task. The system can then produce the user interface based on the retrieved documents and annotations at step 450.

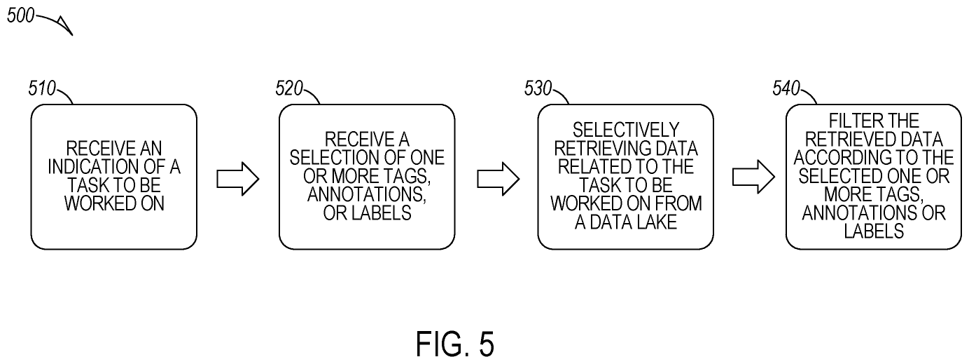

FIG. 5 is a flowchart depicting a method 500 of using a dynamic data resource driven system. The method 500 can include steps 510 to 540 in an example.

At step 510, the system can receive an indication of a task to be worked on. Data related to the task to be worked on can be stored in a data resource. In some cases, receiving an indication of a task to be worked on can include receiving an input from a user. In some cases, receiving an indication of a task to be worked on can include receiving an automated notification from an automated or semi-automated docketing system. In some cases, receiving an indication of a task to be worked on can include receiving an authorization from a customer to proceed.

The data can include one or more documents, deadlines, metadata, or files related to the task to be worked on. In some cases, the documents and data are posted to the computer by a governmental entity. In some cases, the computer includes a database maintained by a third party.

The method can further include deriving annotations from the scraped documents and data and adding those derived annotations to the data resource associated with the documents and data.

Next, at step 520, the system can receive a selection of one or more tags, annotations, or labels applicable to the task to be worked on. In some cases, the method can include tagging, annotating, or labelling data in the data resource prior to selectively retrieving the data. In some cases, the method can include automatically scraping documents and data from a computer to add to the data resource.

At step 530, the method can include selectively retrieving data related to the task to be worked on from a data resource. In some cases, selectively retrieving data related to the task to be worked on can include retrieving one or more documents, retrieving information for display, retrieving editable text, retrieving metadata, or combinations thereof.

In some cases, selectively retrieving data related to the task to be worked on can include receiving documents from an internal system via the data resource. In some cases, selectively retrieving data can include receiving documents from an external system via the data resource. The external system can include a foreign agent system via the data resource. The data can include one or more documents related to the task to be worked on. The one or more documents can include an office action, a prior art citation, a file history document, correspondences, or combinations thereof.

In some cases, the data related to the task to be worked on can include a repository of form language. In some cases, the data related to the task to be worked on can include a repository of references.

At step 540, the system can filter the retrieved data according to the selected one or more tags, annotations, or labels. After filtering the retrieved data, the system can produce, on a user interface, the filtered retrieved data in a dynamic data resource driven tool. The dynamic data resource driven tool can be configurable by the user. The filter can be configurable by the user to display desired stored data from the data resource on the user interface.

In some cases, producing, on a user interface, a dynamic data resource driven tool can include producing at least one reading pane. The at least one reading pane can be dynamically updatable by a user. The at least one reading pane can be configured to display at least a portion of the data related to the task to be worked on. In some cases, producing, on a user interface, a dynamic data resource driven tool can include producing at least one editing pane.

The method can include cross-checking the data related to the task to be worked on. The method can include applying annotations to the data related to the task to be worked on. The method can include producing a JSON file related to the data related to the task to be worked on.

In some cases, the method can include presenting a filtered portion of stored data, editable text, documents, moveable images, displayed data, or combinations thereof on the user interface. In some cases, the method can further include tagging the stored data in the data resource prior to retrieving the stored data. The filter can include a tag selector.

In some cases, the system can be a dynamic legal services tool. The dynamic legal services tool can be actuatable by the user to show different items of data and documents. The dynamic legal services tool can be updatable by the user.

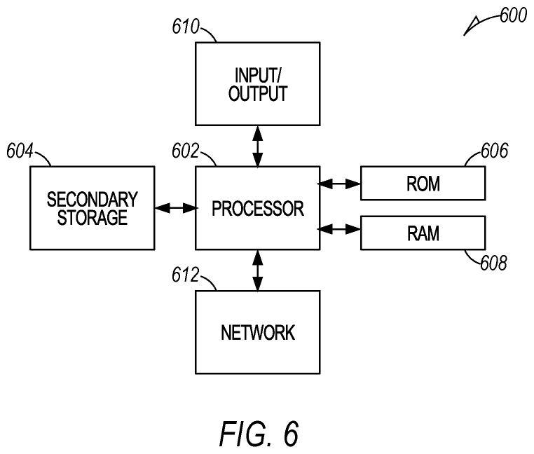

FIG. 6 is a block diagram of a typical, general-purpose computer 600 that can be programmed into a special purpose computer suitable for implementing one or more embodiments of the manifest record generating program disclosed herein. The manifest record generating program described above can be implemented on any general-purpose processing component, such as a computer with sufficient processing power, memory resources, and communications throughput capability to handle the necessary workload placed upon it. The computer 600 includes a processor 602 (which can be referred to as a central processor unit or CPU) that is in communication with memory devices including secondary storage 604, read only memory (ROM) 606, random access memory (RANI) 608, input/output (I/O) devices 610, and network connectivity devices 612. The processor 602 can be implemented as one or more CPU chips or can be part of one or more application specific integrated circuits (ASICs).

The secondary storage 604 is typically comprised of one or more disk drives or tape drives and is used for non-volatile storage of data and as an over-flow data storage device if RAM 608 is not large enough to hold all working data. Secondary storage 604 can be used to store programs that are loaded into RANI 608 when such programs are selected for execution. The ROM 606 is used to store instructions and perhaps data that are read during program execution. ROM 606 is a non-volatile memory device that typically has a small memory capacity relative to the larger memory capacity of secondary storage 604. The RANI 608 is used to store volatile data and perhaps to store instructions. Access to both ROM 606 and RAM 608 is typically faster than to secondary storage 604.

The devices described herein can be configured to include computer-readable non-transitory media storing computer-readable instructions and one or more processors coupled to the memory, and when executing the computer readable instructions configure the computer 600 to perform method and process steps and operations described above with reference to FIG. 3 to FIG. 5. The computer-readable non-transitory media includes all types of computer-readable media, including magnetic storage media, optical storage media, flash media, and solid-state storage media.

It should be further understood that software including one or more computer-executable instructions that facilitate processing and operations as described above with reference to any one or all of steps of the disclosure can be installed in and sold with one or more servers and/or one or more routers and/or one or more devices within consumer and/or producer domains consistent with the disclosure. Alternatively, the software can be obtained and loaded into one or more servers and/or one or more routers and/or one or more devices within consumer and/or producer domains consistent with the disclosure, including obtaining the software through a physical medium or distribution system, including, for example, from a server owned by the software creator or from a server not owned but used by the software creator. The software can be stored on a server for distribution over the Internet, for example.

Also, it will be understood by one skilled in the art that this disclosure is not limited in its application to the details of construction and the arrangement of components set forth in the description or illustrated in the drawings. The embodiments herein are capable of other embodiments, and capable of being practiced or carried out in various ways. Also, it will be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected”, “coupled”, and “mounted”, and variations thereof herein are used broadly and encompass direct and indirect connections, couplings, and mountings. In addition, the terms “connected” and “coupled” and variations thereof are not restricted to physical or mechanical connections or couplings. Further, terms such as up, down, bottom, and top are relative, and are employed to aid illustration, but are not limiting.

The components of the illustrative devices, systems and methods employed in accordance with the illustrated embodiments can be implemented, at least in part, in digital electronic circuitry, analog electronic circuitry, or in computer hardware, firmware, software, or in combinations of them. These components can be implemented, for example, as a computing program product such as a computing program, program code or computer instructions tangibly embodied in an information carrier, or in a machine-readable storage device, for execution by, or to control the operation of, data processing apparatus such as a programmable processor, a computer, or multiple computers.

A computing program can be written in any form of programming language, including compiled or interpreted languages, and it can be deployed in any form, including as a stand-alone program or as a module, component, subroutine, or other unit suitable for use in a computing environment. A computing program can be deployed to be executed on one computer or on multiple computers at one site or distributed across multiple sites and interconnected by a communication network. Also, functional programs, codes, and code segments for accomplishing the techniques described herein can be easily construed as within the scope of the present disclosure by programmers skilled in the art. Method steps associated with the illustrative embodiments can be performed by one or more programmable processors executing a computing program, code or instructions to perform functions (e.g., by operating on input data and/or generating an output). Method steps can also be performed by, and apparatus can be implemented as, special purpose logic circuitry, e.g., an FPGA (field programmable gate array) or an ASIC (application-specific integrated circuit), for example.

The various illustrative logical blocks, modules, and circuits described in connection with the embodiments disclosed herein can be implemented or performed with a general-purpose processor, a digital signal processor (DSP), an ASIC, a FPGA or other programmable logic device, discrete gate or transistor logic, discrete hardware components, or any combination thereof designed to perform the functions described herein. A general-purpose processor can be a microprocessor, but in the alternative, the processor can be any conventional processor, controller, microcontroller, or state machine. A processor can also be implemented as a combination of computing devices, e.g., a combination of a DSP and a microprocessor, a plurality of microprocessors, one or more microprocessors in conjunction with a DSP core, or any other such configuration.

Processors suitable for the execution of a computing program include, by way of example, both general and special purpose microprocessors, and any one or more processors of any kind of digital computer. Generally, a processor will receive instructions and data from a read-only memory, a random-access memory, or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computing program instructions and data include all forms of non-volatile memory, including by way of example, semiconductor memory devices, e.g., electrically programmable read-only memory or ROM (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory can be supplemented by or incorporated in special purpose logic circuitry.

Those of skill in the art understand that information and signals can be represented using any of a variety of different technologies and techniques. For example, data, instructions, commands, information, signals, bits, symbols, and chips that can be referenced throughout the above description can be represented by voltages, currents, electromagnetic waves, magnetic fields or particles, optical fields or particles, or any combination thereof.

Those of skill in the art further appreciate that the various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the disclosure. A software module can reside in random access memory (RAM), flash memory, ROM, EPROM, EEPROM, registers, hard disk, a removable disk, a CD-ROM, or any other form of storage medium known in the art. An exemplary storage medium is coupled to the processor such the processor can read information from, and write information to, the storage medium. In the alternative, the storage medium can be integral to the processor. In other words, the processor and the storage medium can reside in an integrated circuit or be implemented as discrete components.

As used herein, “machine-readable medium” means a device able to store instructions and data temporarily or permanently and can include, but is not limited to, random-access memory (RAM), read-only memory (ROM), buffer memory, flash memory, optical media, magnetic media, cache memory, other types of storage (e.g., Erasable Programmable Read-Only Memory [EEPROM]), and/or any suitable combination thereof. The term “machine-readable medium” should be taken to include a single medium or multiple media (e.g., a centralized or distributed database, or associated caches and servers) able to store processor instructions. The term “machine-readable medium” shall also be taken to include any medium, or combination of multiple media, that is capable of storing instructions for execution by one or more processors, such that the instructions, when executed by one or more processors cause the one or more processors to perform any one or more of the methodologies described herein. Accordingly, a “machine-readable medium” refers to a single storage apparatus or device, as well as “cloud-based” storage systems or storage networks that include multiple storage apparatuses or devices. The term “machine-readable medium” as used herein excludes signals per se.

### VARIOUS NOTES & EXAMPLES

Example 1 is a method comprising: receiving an indication of a task to be worked on; automatically scraping documents and data from a computer to a data resource; deriving annotations from the scraped documents and data and adding those derived annotations to the data resource, the scraped documents and data associated with the task to be worked on; receiving a selection of one or more tags, annotations, or labels applicable to the task to be worked on; tagging, annotating, or labelling data in the data resource; selectively retrieving data related to the task to be worked on from the data resource; wherein selectively retrieving data related to the task to be worked on comprises: retrieving one or more documents; retrieving information for display; retrieving editable text; and retrieving metadata; filtering the retrieved data according to the selected one or more tags, annotations, or labels; and displaying the filtered retrieved data on a dynamic data resource driven user interface tool comprising at least one editing pane.

In Example 2, the subject matter of Example 1 optionally includes wherein receiving an indication of a task to be worked on comprises receiving an input from a user.

In Example 3, the subject matter of any one or more of Examples 1-2 optionally includes wherein documents and data are stored in a data resource, the data resource comprising one or more documents, deadlines, metadata, or files related to the task to be worked on.

In Example 4, the subject matter of any one or more of Examples 1-3 optionally includes wherein the computer comprises a database maintained by a third party.

In Example 5, the subject matter of any one or more of Examples 1-4 optionally includes wherein the documents and data are posted to the computer by a governmental entity.

In Example 6, the subject matter of any one or more of Examples 1-5 optionally includes wherein the dynamic data resource driven user interface tool is configurable by the user.

In Example 7, the subject matter of any one or more of Examples 1-6 optionally includes wherein receiving an indication of a task to be worked on comprises receiving an automated notification from an automated or semi-automated docketing system.

In Example 8, the subject matter of any one or more of Examples 1-7 optionally includes wherein receiving an indication of a task to be worked on comprises an authorization from a customer to proceed.

In Example 9, the subject matter of any one or more of Examples 1-8 optionally includes wherein selectively retrieving data related to the task to be worked on from the data resource comprises receiving documents from an internal system via the data resource.

In Example 10, the subject matter of any one or more of Examples 1-9 optionally includes wherein selectively retrieving data related to the task to be worked on from the data resource comprises receiving documents from an external system via the data resource, wherein the external system comprises a foreign agent system via the data resource.

In Example 11, the subject matter of any one or more of Examples 1-10 optionally includes wherein the data related to the task to be worked on comprises one or more documents related to the task to be worked on, wherein the one or more documents comprises an office action, a prior art citation, a file history document, correspondence, or combinations thereof.

In Example 12, the subject matter of any one or more of Examples 1-11 optionally includes wherein displaying the filtered retrieved data on a dynamic data resource driven user interface comprises producing at least one reading pane, wherein the at least one reading pane is dynamically updatable by a user and is configured to display at least a portion of the data related to the task to be worked on.

In Example 13, the subject matter of any one or more of Examples 1-12 optionally includes wherein the data related to the task to be worked on comprises a repository of form language.

In Example 14, the subject matter of any one or more of Examples 1-13 optionally includes wherein the data related to the task to be worked on comprises a repository of references.

In Example 15, the subject matter of any one or more of Examples 1-14 optionally includes wherein the method further comprises cross-checking the data related to the task to be worked on.

In Example 16, the subject matter of any one or more of Examples 1-15 optionally includes wherein the method further comprises applying annotations to the data related to the task to be worked on.

In Example 17, the subject matter of any one or more of Examples 1-16 optionally includes wherein the method further comprises producing a JSON file related to the task to be worked on.

Example 18 is a method comprising: tagging stored data in a data resource with a plurality of tags indicative of data type; retrieving the stored data from the data resource; applying a filter to select a portion of the plurality of tags, and; displaying a filtered portion of the stored data based on the filter on a user interface as a dynamic data resource driven user interface tool, wherein displaying the filtered portion of the stored data comprises displaying editable text, documents, moveable images, displayed data, or combinations thereof on the user interface, and wherein the dynamic data resource driven user interface tool is configurable and updatable by a user.

In Example 19, the subject matter of Example 18 optionally includes wherein the filter is configurable by the user to display desired stored data from the data resource on the user interface.

Example 20 is a system comprising: a data resource comprising data related to one or more tasks to be worked on, the data comprising one or more deadlines, documents, and other items related to the task to be worked on; wherein the data resource is configured to: interface with an internal docketing system, interface with an external docketing system, and interface with an annotation system; a dynamic data resource driven user interface tool for use in completing the one or more tasks to be worked on, the dynamic data resource driven user interface tool configured to dynamically update, wherein the dynamic data resource driven user interface tool comprises a template for one or more tasks to be worked on, the template populated by the dynamic data resource driven user interface tool with the data related to one or more tasks to be worked on; wherein the dynamic data resource driven user interface tool comprises: one or more reading panes for displaying at least a portion of the data related to one or more tasks to be worked on; and one or more editing panes for production of a new document related to the one or more tasks to be worked on; wherein the dynamic data resource driven user interface tool is configured to: interact with the data resource; retrieve data from the data resource; produce the data from the data resource on the dynamic data resource driven user interface tool; and dynamically update the dynamic data resource driven user interface.

Each of these non-limiting examples can stand on its own or can be combined in various permutations or combinations with one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code can form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) can be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method comprising:
receiving an indication of a task to be worked on;
automatically scraping documents and data from a computer to a data resource;
deriving annotations from the scraped documents and data and adding those derived annotations to the data resource, the scraped documents and data associated with the task to be worked on;
receiving a selection of one or more tags, annotations, or labels applicable to the task to be worked on;
tagging, annotating, or labelling data in the data resource;
selectively retrieving data related to the task to be worked on from the data resource;
wherein selectively retrieving data related to the task to be worked on comprises:
retrieving one or more documents;
retrieving information for display;
retrieving editable text; and
retrieving metadata;
filtering the retrieved data according to the selected one or more tags, annotations, or labels; and
displaying the filtered retrieved data on a dynamic data resource driven user interface tool comprising at least one editing pane.

2. The method of claim 1, wherein receiving an indication of a task to be worked on comprises receiving an input from a user.

3. The method of claim 1, wherein documents and data are stored in a data resource, the data resource comprising one or more documents, deadlines, metadata, or files related to the task to be worked on.

4. The method of claim 1, wherein the computer comprises a database maintained by a third party.

5. The method of claim 1, wherein the documents and data are posted to the computer by a governmental entity.

6. The method of claim 1, wherein the dynamic data resource driven user interface tool is configurable by a user.

7. The method of claim 1, wherein receiving an indication of a task to be worked on comprises receiving an automated notification from an automated or semi-automated docketing system.

8. The method of claim 1, wherein receiving an indication of a task to be worked on comprises receiving an authorization from a customer to proceed.

9. The method of claim 1, wherein selectively retrieving data related to the task to be worked on from the data resource comprises receiving documents from an internal system via the data resource.

10. The method of claim 1, wherein selectively retrieving data related to the task to be worked on from the data resource comprises receiving documents from an external system via the data resource, wherein the external system comprises a foreign agent system via the data resource.

11. The method of claim 1, wherein the data related to the task to be worked on comprises one or more documents related to the task to be worked on, wherein the one or more documents comprises an office action, a prior art citation, a file history document, correspondence, or combinations thereof.

12. The method of claim 1, wherein displaying the filtered retrieved data on a dynamic data resource driven user interface tool comprises producing at least one reading pane, wherein the at least one reading pane is dynamically updatable by a user and is configured to display at least a portion of the data related to the task to be worked on.

13. The method of claim 1, wherein the data related to the task to be worked on comprises a repository of form language.

14. The method of claim 1, wherein the data related to the task to be worked on comprises a repository of references.

15. The method of claim 1, further comprising cross-checking the data related to the task to be worked on.

16. The method of claim 1, wherein the method further comprises applying annotations to the data related to the task to be worked on.

17. The method of claim 1, further comprising producing a JSON file related to the data related to the task to be worked on.

18. A method comprising:
tagging stored data in a data resource with a plurality of tags indicative of data type;
retrieving the stored data from the data resource;
applying a filter to select a portion of the plurality of tags, and;
displaying a filtered portion of the stored data based on the filter on a user interface as a dynamic data resource driven user interface tool, wherein displaying the filtered portion of the stored data comprises displaying editable text, documents, moveable images, displayed data, or combinations thereof on the user interface, and wherein the dynamic data resource driven user interface tool is configurable and updatable by a user.

19. The method of claim 18, wherein the filter is configurable by the user to display desired stored data from the data resource on the user interface.

20. A system comprising:
a data resource comprising data related to one or more tasks to be worked on, the data comprising one or more deadlines, documents, and other items related to the task to be worked on;
wherein the data resource is configured to:
interface with an internal docketing system,
interface with an external docketing system, and,
interface with an annotation system;
a dynamic data resource driven user interface tool for use in completing the one or more tasks to be worked on, the dynamic data resource driven user interface tool configured to dynamically update, wherein the dynamic data resource driven user interface tool comprises a template for one or more tasks to be worked on, the template populated by the dynamic data resource driven user interface tool with the data related to one or more tasks to be worked on;
wherein the dynamic data resource driven user interface tool comprises:
one or more reading panes for displaying at least a portion of the data related to one or more tasks to be worked on; and
one or more editing panes for production of a new document related to the one or more tasks to be worked on;
wherein the dynamic data resource driven user interface tool is configured to:
interact with the data resource;
retrieve data from the data resource;
produce the data from the data resource on the dynamic data resource driven user interface tool; and
dynamically update the dynamic data resource driven user interface.
